(19) United States
(12) Patent Application Publication
(10) Pub. No.: US 2023/0132816 A1
(43) Pub. Date: May 4, 2023

(54) Tarp spooling device

(71) Applicant: Chung-Hsien HSIEH, New Taipei City (TW)

(72) Inventor: Chung-Hsien HSIEH, New Taipei City (TW)

(21) Appl. No.: 17/843,025

(22) Filed: Jun. 17, 2022

(30) Foreign Application Priority Data
Oct. 29, 2021 (TW) 110140273

(51) Int. Cl. B60P 7/08; B60P 7/04

(52) U.S. Cl. CPC B60P 7/0876; B60P 7/04

(57) ABSTRACT

The invention relates to a tarp spooling device, mainly comprising a motor, a reduction gear set, a bevel gear set, a tarp reel, and a clutch, wherein the reduction gear set is coupled to the rotor shaft of the motor, the bevel gear set is coupled to the reduction gear set, the tarp reel is coupled to the bevel gear set, and the clutch is coupled between the reduction gear set and the bevel gear set. When the motor is activated, the rotor shaft drives the tarp reel to rotate through the reduction gear set, the bevel gear set, and the clutch; and when the motor is deactivated, the clutch locks the tarp reel, and the tarp reel is unable to be rotated. When the motor is deactivated, the clutch is self-locked, and only when the motor is activated again, the tarp reel can be rotated again.

### BACKGROUND OF THE INVENTION

### Field of the Invention

The present invention relates to a tarp spooling device for spooling or unspooling a tarp which is particularly suitable for a vehicle or a building.

### Description of the Related Art

For many vehicles with an open bed for carrying cargo, a tarp for protecting the cargo from being wetted or from external environment is used. For example, in the case of a gravel truck, a tarp is capable of preventing the carried gravel from falling from the gravel truck. This is especially important when the gravel truck travels at high speed because the falling gravel may injure pedestrians or damage vehicles on the road.

Traditionally, a tarp is manually attached to a vehicle by means of hooks or ropes. It is time-consuming and labor-intensive. The tarp may be detached from the vehicle due to human negligence.

Currently, there are electric spooling devices which are commercially available. As disclosed in U.S. Pat. No. 10,518,618 B2 entitled “TARP MOTOR ASSEMBLY”, a combination of a worm screw and a worm gear for gear reduction is used to prevent reverse rotation, and a reduction gear mechanism of spur gears is included.

However, such a mechanism which prevents reverse rotation solely by the worm screw and the worm gear may still allow slow rotation when the motor is deactivated. It is difficult for such a mechanism to have a reliable self-lock function. Especially, when it is used in a vehicle, the tarp may be spooled or unspooled unexpectedly due to frequent vibrations if the vehicle has traveled for a long time. When a tarp reel is forcibly rotated or reversed by an external force, cracks in the worm screw and the worm gear may occur. After long-term use, the meshing surfaces of the worm screw and the worm gear are seriously worn, the service life is short, heat is generated easily during operation, and the operation efficiency is also poor.

### SUMMARY OF THE INVENTION

One of the main objects of the present invention is to provide a tarp spooling device which is capable of being completely self-locked when the motor is deactivated and which has a better transmission efficiency and a longer service life.

In order to achieve the foregoing object, the present invention provides a tarp spooling device, mainly comprising a motor, at least one reduction gear set, a bevel gear set, a tarp reel and a clutch, wherein the motor includes a rotor shaft, the at least one reduction gear set is coupled to the rotor shaft, the bevel gear set is coupled to the at least one reduction gear set, the tarp reel is coupled to the bevel gear set, the clutch is coupled between the at least one reduction gear set and the bevel gear set or between the bevel gear set and the tarp reel. When the motor is activated, the tarp reel is rotated by the rotor shaft through the at least one reduction gear set, the bevel gear set and the clutch. When the motor is deactivated, the clutch locks the tarp reel so that the tarp reel is unable to be rotated.

Accordingly, the present invention can convert the rotational speed of the rotor shaft of the motor to a reduced rotational speed and increase a torque by means of the reduction gear set and can change the direction of power transmission by means of the bevel gear set and prevent the tarp reel from being rotated by means of the clutch. When the motor is deactivated, the clutch is self-locked. Only when the motor is activated again, the tarp reel can be rotated. No unexpected spooling or unspooling occurs.

In order to achieve the foregoing object, the present invention further provides a tarp spooling device, mainly comprising a motor, at least one reduction gear set, a transmission direction changing component, a tarp reel and a clutch, wherein the motor includes a rotor shaft, the at least one reduction gear set is coupled to the rotor shaft, the transmission direction changing component includes an input end and an output end, the input end is coupled to the at least one reduction gear set, the tarp reel is coupled to the output end of the transmission direction changing component, the clutch is coupled between the at least one reduction gear set and the transmission direction changing component or between the transmission direction changing component and the tarp reel. When the motor is activated, the tarp reel is rotated by the rotor shaft through the at least one reduction gear set, the transmission direction changing component and the clutch. When the motor is deactivated, the tarp reel is locked by the clutch so that the tarp reel is unable to be rotated.

In other words, the present invention can change the power transmission direction by means of the transmission direction changing component. The axis of the rotor shaft of the motor can be inclined to the axis of the tarp reel by a specific angle which may be an orthogonal angle or an arbitrary angle. The transmission direction changing component may be, for example, a bevel gear set, a crossed helical gear set, a universal joint, or other equivalent mechanisms or components that can change the transmission direction.

In order to achieve the foregoing object, the present invention provides a tarp spooling device, mainly comprising a motor, at least one reduction gear set, a bevel gear set, a tarp reel and a clutch, wherein the motor includes a rotor shaft, the at least one reduction gear set is coupled to the rotor shaft, the bevel gear set is coupled to the at least one reduction gear set, the tarp reel is coupled to the bevel gear set, and the clutch is coupled between the at least one reduction gear set and the bevel gear set. The clutch includes an outer sleeve, a rotary disk, a plurality of cylindrical stoppers and a central rotary block. The rotary disk is coupled to the at least one reduction gear set, and the central rotary block is coupled to the bevel gear set. An end surface of the rotary disk is provided with a plurality of cylindrical push blocks. The plurality of cylindrical push blocks and the central rotary block are accommodated in the outer sleeve. An outer circumferential surface of the central rotary block includes a plurality of first sections and a plurality of second sections which are arranged alternately. Each cylindrical push block is arranged between an inner circumferential surface of the outer sleeve and a respective one of the first sections. Each cylindrical stopper is arranged between the inner circumferential surface of the outer sleeve and a respective one of the plurality of second sections. A retaining ridge is formed between the adjacent first section and second section, and a retaining gap is formed between the retaining ridge and the inner circumferential surface of the outer sleeve. When the motor is activated, the rotary disk is rotated by the rotor shaft through the at least one reduction gear set, and the plurality of cylindrical push blocks pass through the retaining gap and push the plurality of cylindrical stoppers respectively, thereby causing the central rotary block to rotate. The bevel gear set is rotated together with the central rotary block, thereby causing the tarp reel to rotate. When the motor is deactivated, the cylindrical stopper is retained in the retaining gap so that the central rotary block is unable to be rotated together with the tarp reel.

Accordingly, the clutch of the present invention realizes the transmission function during a normal operation period and the self-locking function during a non-operation period. Specifically, when the motor is activated, the clutch serves as a transmission part to drive the tarp reel to rotate; when the motor is deactivated, the clutch is locked by retaining the cylindrical stoppers in the retaining gap (i.e., the interval between the retaining ridge of the central rotary block and the inner circumferential surface of the outer sleeve), thereby braking the central rotary block connected to the tarp reel so that the tarp reel is unable to be rotated arbitrarily. On the other hand, when the motor is activated again, the rotary disk is rotated by the motor, and the cylindrical push blocks on the rotary disk push the cylindrical stoppers so that the cylindrical stoppers escape from the retaining gap, thereby causing the tarp reel to rotate.

### BRIEF DESCRIPTION OF THE DRAWINGS

FIG. 1 is a view showing a preferred embodiment of the present invention in use.

FIG. 2 is a perspective view of a preferred embodiment of the present invention with a casing being removed.

FIG. 3 is an exploded view of the preferred embodiment of the present invention with the casing being removed.

FIG. 4A is a front view of a clutch according to a preferred embodiment of the present invention.

FIG. 4B is an exploded view of the clutch according to the preferred embodiment of the present invention.

FIG. 4C is a partial enlarged view of the clutch according to the preferred embodiment of the present invention.

### DESCRIPTION OF THE PREFERRED EMBODIMENTS

Before a tarp spooling device of the present invention is described in detail in the embodiments, it should be noted that, in the following description, similar elements will be denoted by the same reference numerals. Furthermore, the drawings of the present invention are for illustrative purposes only, they are not necessarily drawn to scale, and not all details are necessarily shown in the drawings.

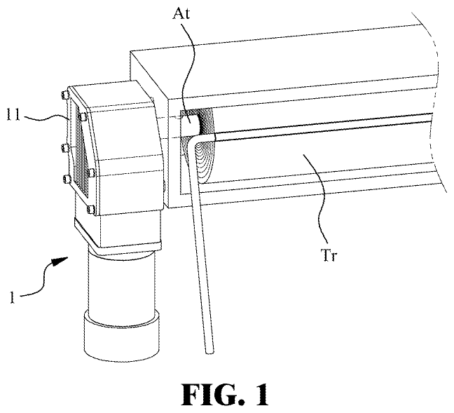

Reference is made to FIG. 1 which is a view showing a preferred embodiment of the present invention in use. As shown in the figure, a tarp spooling device 1 of this embodiment functions to unspool a tarp Tr so that the tarp Tr can be put up and also functions to spool the tarp Tr on a tarp reel At. The present invention can be arranged on not only a vehicle for preventing cargo from contaminating the external environment or from being contaminated by the external environment, but also the present invention can be installed on a building, for example, for sun shading or for rain sheltering.

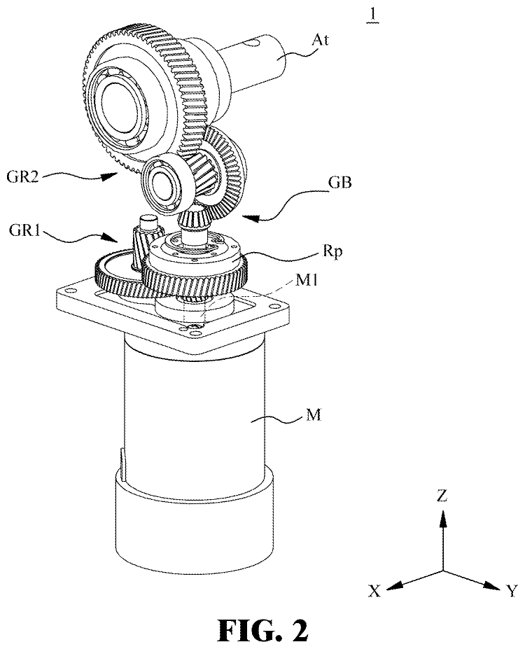

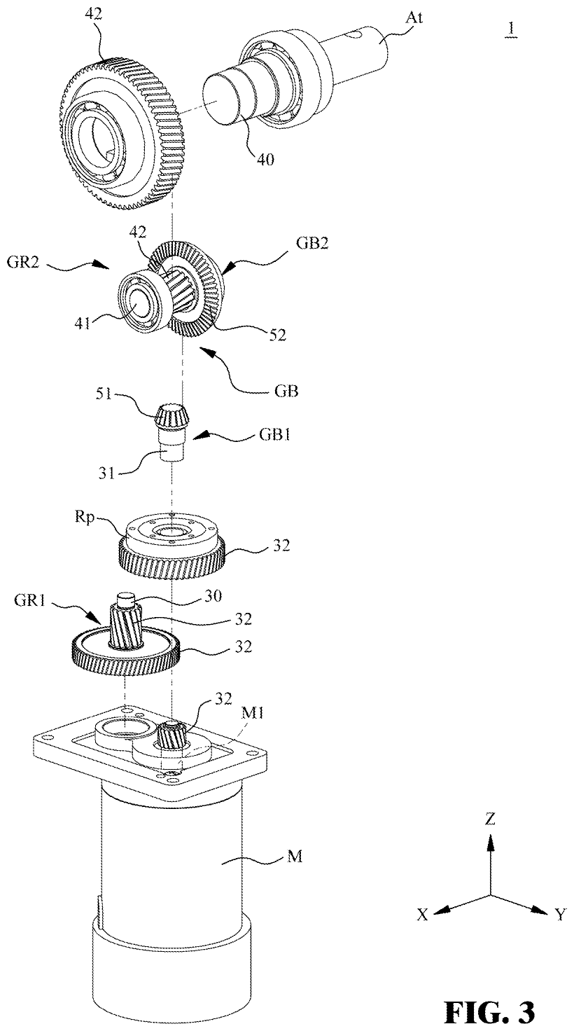

Reference is made to FIG. 2 and FIG. 3. FIG. 2 is a perspective view of a preferred embodiment of the present invention with the casing 11 being removed, and FIG. 3 is an exploded view of the preferred embodiment of the present invention with the casing 11 being removed. As shown in the figures, the tarp spooling device 1 of this embodiment mainly includes a motor M, a first reduction gear set GR1, a second reduction gear set GR2, a bevel gear set GB, a clutch Rp and a tarp reel At.

The motor M includes a rotor shaft M1. The rotor shaft M1 in this embodiment is directly connected to the first reduction gear set GR1. Specifically, the first reduction gear set GR1 of this embodiment includes two first shafts 30, 31 and four first helical gears 32. The first shafts 30, 31 are parallel to the rotor shaft M1, the helical gears 32 each have a number of teeth different from the others and are respectively mounted on the first shafts 30, 31 and the rotor shaft M1 and engaged with one another. Accordingly, the first reduction gear set GR1 appropriately reduces the rotational speed of the rotor shaft M1. In the embodiment, the helical gears serving as reduction gears has the advantages of uniform transmission and low noise and is suitable for high-speed rotation.

As shown in the figure, the bevel gear set GB is coupled to the first reduction gear set GR1. The bevel gear set GB in this embodiment serves as a transmission direction changing component, which can change the power transmission direction. The transmission direction changing component includes an input end GB1 and an output end GB2, wherein the input end GB1 is coupled to the rotor shaft M1 through the first reduction gear set GR1, and the output end GB2 is coupled to the tarp reel At through the second reduction gear set GR2.

The bevel gear set GB of this embodiment includes a first bevel gear 51 and a second bevel gear 52, wherein the first bevel gear 51 is mounted on the most downstream first shaft 31 of the first reduction gear set GR1, the second bevel gear 52 is mounted on the most upstream second shaft 41 of the second reduction gear set GR2, and the first bevel gear 51 is orthogonally engaged with the second bevel gear 52. Accordingly, in this embodiment, by means of the bevel gear set GB, the axis of the rotor shaft M1 can be arranged to be orthogonal to the axis of the tarp reel At, that is, the rotor shaft M1 of the motor M originally rotates about a Z axis, and the power transmission direction is changed by the bevel gear set GB so that the tarp reel At rotates about an X axis.

The second reduction gear set GR2 is coupled between the bevel gear set GB and the tarp reel At. The second reduction gear set GR2 in this embodiment includes two second shafts 40, 41 and two second helical gears 42, wherein the second shaft 40 is coaxially connected to the tarp reel At, and the second shaft 41 is parallel to the tarp reel At. The second helical gears 42 are respectively mounted on the second shafts 40, 41 and engaged with each other. Accordingly, in this embodiment, a second-stage gear reduction is implemented by the second reduction gear set GR2.

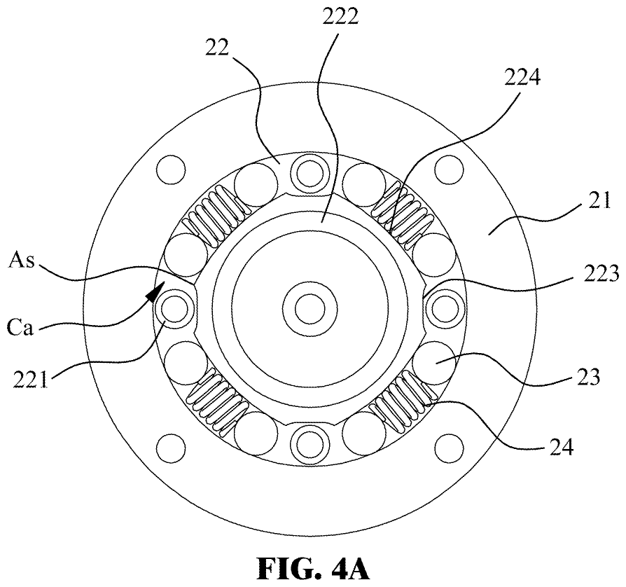

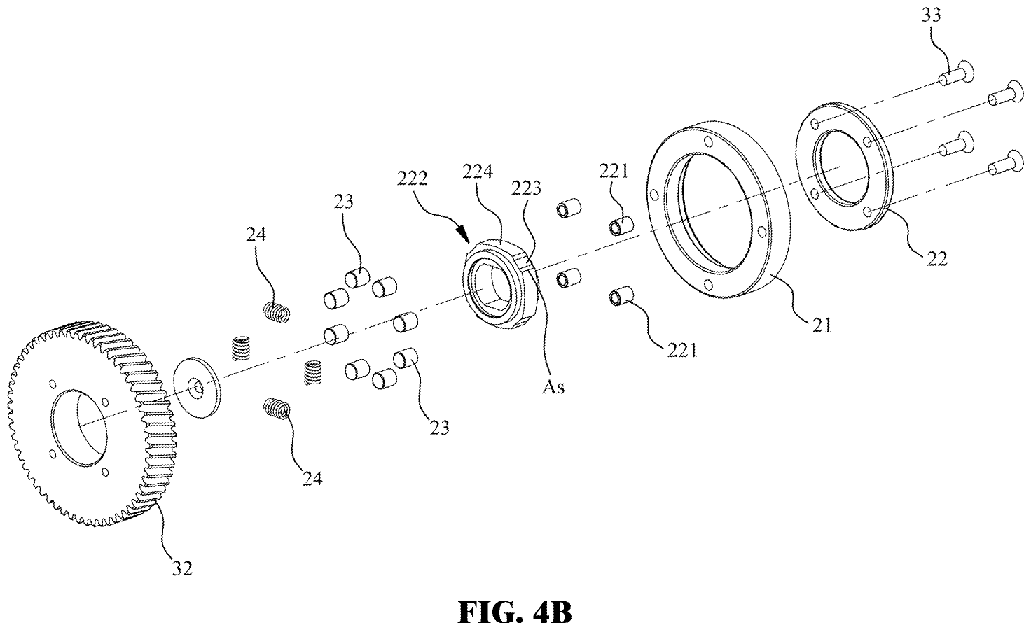

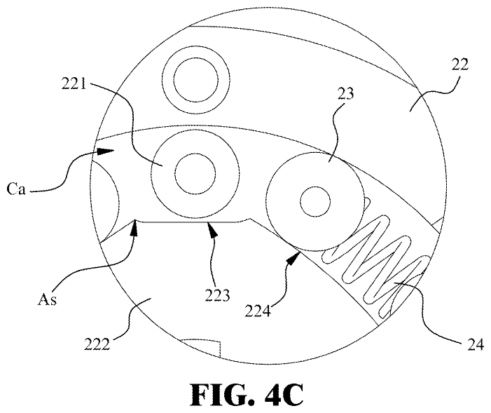

Reference is made to FIGS. 4A, 4B and 4C. FIG. 4A is a front view of the clutch Rp according to a preferred embodiment of the present invention, FIG. 4B is an exploded view of the clutch according to the preferred embodiment of the present invention, and FIG. 4C is a partial enlarged view of the clutch according to the preferred embodiment of the present invention. The clutch Rp in this embodiment mainly serves as a transmission component when the motor M is activated so that the motor M can drive the tarp reel At to rotate, and the clutch Rp locks the tarp reel At when the motor M is deactivated so that the tarp reel At cannot be rotated.

Specifically, the clutch Rp of the present embodiment mainly includes an outer sleeve 21, a rotary disk 22, eight cylindrical stopper 23 and a central rotary block 222. The rotary disk 22 is connected to the first helical gear 32 by means of screws 33, that is, the rotary disk 22 is coupled to the rotor shaft M1. Reference is made to FIG. 3. The central rotary block 222 is connected to one end of the first shaft 31, and the other end of the first shaft 31 is connected to the first bevel gear 51, that is, the central rotary block 222 is coupled to the tarp reel At. The outer circumferential surface of the central rotary block 222 includes four first sections 223 and four second sections 224 arranged alternately, wherein the first section 223 is a concavely curved surface, the second section 224 is convexly curved surface, and the length of the second section 224 is greater than that of the first section 223.

One end surface of the rotary disk 22 is provided with four cylindrical push blocks 221 equidistantly distributed. The cylindrical push blocks 221 and the central rotary block 222 are accommodated in the outer sleeve 21. The four cylindrical push blocks 221 are respectively disposed between the four first sections 223 and the inner circumferential surface of the outer sleeve 21, and two cylindrical stoppers 23 and a coil spring 24 are disposed between each second section 224 and the inner circumferential surface of the outer sleeve 21. The coil spring 24 is used to bias the two cylindrical stoppers 23 away from each other.

A retaining ridge As is formed between each first section 223 and each second section 224, and a retaining gap Ca is formed between the tip of the retaining ridge As and the inner circumferential surface of the outer sleeve 21. The retaining gap Ca is configured to allow the cylindrical push block 221 to pass through, while the cylindrical stopper 23 cannot pass through the retaining gap Ca.

In this way, when the rotary disk 22 is driven to rotate by the motor M, the cylindrical push block 221 passes through the retaining gap Ca and pushes the cylindrical stopper 23, so that the central rotary block 222 is rotated accordingly so as to indirectly drive the tarp reel At to rotate. On the other hand, when the motor M is deactivated, the cylindrical stopper 23 is biased toward the retaining gap Ca by the coil spring 24. At this time, even if the tarp reel At tends to be rotated, that is, the central rotary block 222 tends to be rotated, the cylindrical stopper 23 would be locked in the retaining gap Ca, so that the central rotary block 222 cannot be rotated in either direction.

In other words, the present embodiment has at least the following advantages:

1. When the motor is activated, the clutch functions to transmit power, and when the motor is deactivated, the clutch functions to lock the tarp reel, that is, when the motor rotates, the clutch serves as a power transmission mechanism to drive the tarp reel to rotate, and when the motor stops rotating, the clutch automatically locks the tarp reel and effectively prevents the tarp reel from being rotated. Even if vibrations are transmitted to the tarp reel or an external force is exerted on the tarp reel, the tarp would not be spooled or unspooled unexpectedly. This is especially suitable for use in vehicles.
2. The axis of the rotor shaft of the motor can be arranged at an orthogonal angle or an arbitrary angle to the axis of the tarp reel. It breaks through a limit of the conventional technology that power is transmitted at an orthogonal angle due to use of a worm gear and a worm screw. For example, a bevel gear set, a hypoid gear set, a crossed helical gear set, a universal joint or other equivalent mechanisms or components that can change the transmission direction can be used.
3. The bevel gear set serves as a transmission direction changing component, so a larger reduction ratio can be obtained, the operation is more stable, and the adverse effects such as vibrations and noise can be improved. In addition, the power transmission direction can be more flexible, transmission of a greater torque is allowed, and it is capable of bearing a greater load.
4. The helical gears serving as a reduction gear is capable of transmitting large power and rotate at high speed smoothly with low noise.
5. The clutch according to this embodiment has a low profile, occupies a small space, operates smoothly with low noise and has a great self-locking ability. The clutch can completely prevent unexpected rotation when the motor is deactivated.

The preferred embodiment of the present invention is illustrative only, and the claimed inventions are not limited to the details disclosed in the drawings and the specification. Accordingly, it is intended that it have the full scope permitted by the language of the following claims.

What is claimed is:

1. A tarp spooling device, comprising:
a motor, including a rotor shaft;
at least one reduction gear set, coupled to the rotor shaft;
a bevel gear set, coupled to the at least one reduction gear set;
a tarp reel, coupled to the bevel gear set; and
a clutch, coupled between the at least one reduction gear set and the bevel gear set or between the bevel gear set and the tarp reel,
wherein when the motor is activated, the rotor shaft drives the tarp reel to rotate through the at least one reduction gear set, the bevel gear set, and the clutch; when the motor is deactivated, the clutch locks the tarp reel so that the tarp reel is unable to be rotated.

2. The tarp spooling device of claim 1, wherein the clutch includes an outer sleeve, a rotary disk, a plurality of cylindrical stoppers, and a central rotary block; the rotary disk is coupled to the rotor shaft, and the central rotary block is coupled to the tarp reel; an end surface of the rotary disk is provided with a plurality of cylindrical push blocks; the plurality of cylindrical push blocks and the central rotary block are accommodated in the outer sleeve; an outer circumferential surface of the central rotary block includes a plurality of first sections and a plurality of second sections which are arranged alternately; the plurality of cylindrical push blocks are respectively arranged between the plurality of first sections and an inner circumferential surface of the outer sleeve, and the plurality of cylindrical stoppers are respectively arranged between the plurality of second sections and the inner circumferential surface of the outer sleeve; a retaining ridge is included between each first section and each second section, and a retaining gap is formed between the retaining ridge and the inner circumferential surface of the outer sleeve; when the rotor shaft drives the rotary disk to rotate, the plurality of cylindrical push blocks pass through the retaining gap and push the plurality of cylindrical stoppers respectively, thereby causing the central rotary block to rotate; when the rotor shaft stops driving the rotary disk, the cylindrical stopper is locked in the retaining gap.

3. The tarp spooling device of claim 2, wherein the clutch further includes a plurality of coil springs, one of which is arranged between every two cylindrical stoppers; when the rotor shaft stops driving the rotary disk to rotate, the coil spring biases the cylindrical stopper so that the cylindrical stopper is locked in the retaining gap.

4. The tarp spooling device of claim 1, comprising a first reduction gear set and a second reduction gear set, wherein the first reduction gear set is coupled between the rotor shaft and the clutch, and the second reduction gear set is coupled between the bevel gear set and the tarp reel.

5. The tarp spooling device of claim 4, wherein the first reduction gear set includes a plurality of first shafts and a plurality of first helical gears, the plurality of first shafts are parallel to the rotor shaft, the plurality of first helical gears are respectively assembled on the plurality of first shafts and engaged with each other; the second reduction gear set includes a plurality of second shafts and a plurality of second helical gears, the plurality of second shafts are parallel to the tarp reel, the plurality of second helical gears are respectively assembled on the plurality of second shafts and engaged with each other.

6. The tarp spooling device of claim 5, wherein the bevel gear set includes a first bevel gear and a second bevel gear, the first bevel gear is arranged on one of the plurality of first shafts, and the second bevel gear is arranged on one of the plurality of second shafts; the first bevel gear is orthogonally engaged with the second bevel gear.

7. A tarp spooling device, comprising:
a motor, including a rotor shaft;
at least one reduction gear set, coupled to the rotor shaft;
a transmission direction changing component for changing a power transmission direction, including an input end and an output end, the input end being coupled to the at least one reduction gear set;
a tarp reel, coupled to the output end of the transmission direction changing component; and
a clutch, coupled between the at least one reduction gear set and the transmission direction changing component or between the transmission direction changing component and the tarp reel,
wherein when the motor is activated, the rotor shaft drives the tarp reel to rotate through the at least one reduction gear set, the transmission direction changing component, and the clutch; when the motor id deactivated, the clutch locks the tarp reel so that the tarp reel is unable to be rotated.

8. The tarp spooling device of claim 7, wherein the transmission direction changing component is composed of a bevel gear set, and the at least one reduction gear set is composed of a plurality of helical gears.

9. The tarp spooling device of claim 7, wherein the clutch includes an outer sleeve, a rotary disk, a plurality of cylindrical stoppers, and a central rotary block; the rotary disk is coupled to the rotor shaft, and the central rotary block is coupled to the tarp reel; an end surface of the rotary disk is provided with a plurality of cylindrical push blocks; the plurality of cylindrical push blocks and the central rotary block are accommodated in the outer sleeve; an outer circumferential surface of the central rotary block includes a plurality of first sections and a plurality of second sections which are arranged alternately; the plurality of cylindrical push blocks are respectively arranged between the plurality of first sections and an inner circumferential surface of the outer sleeve, and the plurality of cylindrical stoppers are respectively arranged between the plurality of second sections and the inner circumferential surface of the outer sleeve; a retaining ridge is included between each first section and each second section, and a retaining gap is formed between the retaining ridge and the inner circumferential surface of the outer sleeve; when the rotor shaft drives the rotary disk to rotate, the plurality of cylindrical push blocks pass through the retaining gap and push the plurality of cylindrical stoppers respectively, thereby causing the central rotary block to rotate; when the rotor shaft stops driving the rotary disk, the cylindrical stopper is locked in the retaining gap.

10. A tarp spooling device, comprising:
a motor, including a rotor shaft;
at least one reduction gear set, coupled to the rotor shaft;
a bevel gear set, coupled to the at least one reduction gear set;
a tarp reel, coupled to the bevel gear set; and
a clutch, coupled between the at least one reduction gear set and the bevel gear set; the clutch includes an outer sleeve, a rotary disk, a plurality of cylindrical stoppers, and a central rotary block; the rotary disk is coupled to the at least one reduction gear set, and the central rotary block is coupled to the bevel gear set; an end surface of the rotary disk is provided with a plurality of cylindrical push blocks; the plurality of cylindrical push blocks and the central rotary block are accommodated in the outer sleeve; an outer circumferential surface of the central rotary block includes a plurality of first sections and a plurality of second sections which are arranged alternately; the plurality of cylindrical push blocks are respectively arranged between the plurality of first sections and an inner circumferential surface of the outer sleeve, and the plurality of cylindrical stoppers are respectively arranged between the plurality of second sections and the inner circumferential surface of the outer sleeve; a retaining ridge is included between each first section and each second section, and a retaining gap is formed between the retaining ridge and the inner circumferential surface of the outer sleeve,
wherein when the motor is activated, the rotor shaft rotates and drives the rotary disk to rotate through the at least one reduction gear set, and the plurality of cylindrical push blocks pass through the retaining gap and push the plurality of cylindrical stoppers respectively, thereby causing the central rotary block to rotate, and the central rotary block drives the bevel gear set, thereby causing the tarp reel to rotate; when the motor is deactivated, the cylindrical stopper is locked in the retaining gap so that the central rotary block is unable to be rotated together with the tarp reel.
